(19) United States
(12) Patent Application Publication
(10) Pub. No.: US 2007/0091498 A1
(43) Pub. Date: Apr. 26, 2007

(54) Information processing apparatus, data storage method, and data storage program

(75) Inventor: Tsutomu Fujimori, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/585,185

(22) Filed: Oct. 24, 2006

(30) Foreign Application Priority Data
Oct. 25, 2005 (JP) 310008/2005

(51) Int. Cl. G11B 5/09; G11B 27/36

(52) U.S. Cl. 360/53; 360/31

(57) ABSTRACT

An information processing apparatus includes a hard disk drive that includes a hard disk, a writing unit that writes a data file to the hard disk, a reading unit that reads the data file written to the hard disk, a comparing unit that compares the data file written by the writing unit with the data file read by the reading unit, and a control unit that causes the writing unit to perform writing, the reading unit to perform reading, and the comparing unit to perform comparison when the written data file does not coincide with the read data file.

### CROSS-REFERENCE TO RELATED APPLICATIONS

This application claims the benefit of priority of Japanese Patent Application No. 2005-310008, filed Oct. 25, 2005, the entire contents of which are incorporated herein by reference.

### BACKGROUND

1. Field

The present invention relates to information processing apparatuses, data storage methods, and data storage programs, and in particular, relates to an information processing apparatus that includes a hard disk drive, a data storage method for storing data in a hard disk drive, and a data storage program for storing data in a hard disk drive.

2. Description of the Related Art

In known recording and playback devices for writable optical disks and the like, verification is performed for reading data that has been just written and checking the data for errors to improve the reliability of the written data. Inevitably, the throughput is reduced by verification. Thus, for example, a technique is disclosed in JP-A 2-149977, in which an option of performing verification is selected manually or automatically on the basis of the length of data to be written.

On the other hand, in information processing apparatuses such as personal computers, hard disk drives are widely used as units for storing OSs, application programs, and various types of data file.

In general, verification is not performed in hard disk drives. The main reasons are as follows: Write and read operations for hard disk drives need to be extremely fast compared with those for optical disks; and the write error rate of hard disk drives is relatively small compared with that of optical disks.

However, in practice, even when a sequence of write operations seems to have been normally completed, defects may be produced in data written to a hard disk drive. In this case, an error may occur upon reading the corresponding data file, or a part of data that is read from the hard disk drive may be broken.

In a general personal computer, even when a write error occurs in the hard disk drive, the error cannot be detected in some cases. Some files of an OS, in which, for example, the startup time and data on hardware at the startup time are recorded and updated, are updated as necessary, for example, when a personal computer and the like are started up or shut down or are being used. In a case where such files of an OS are broken, when a personal computer is started up for the next time, the personal computer may not be normally started up.

Moreover, when important data stored in a hard disk drive is broken, the damage is enormous.

One method for preventing errors due to defective writing of data on a hard disk drive is redundancy implemented by means of a RAID (Redundant Arrays of Inexpensive Disks) device. However, in this method, additional hardware is needed, and thus the cost increases. Moreover, sacrifices are necessary to store redundant data in a hard disk drive. For example, an available storage area of a hard disk drive is reduced. Thus, redundancy implemented by means of a RAID device is not adopted except when high reliability is required.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is an external view of a notebook personal computer that is a typical example of an information processing apparatus according to an embodiment of the present invention;

FIG. 2 is a block diagram showing a typical system configuration of the information processing apparatus according to the embodiment of the present invention;

FIG. 3 is a functional block diagram showing functions provided in the information processing apparatus according to the embodiment of the present invention;

FIG. 4 is an illustration showing a typical file structure of a data file handled in the embodiment of the present invention; and

FIG. 5 is a flowchart showing a typical process flow of a data storage method and a typical process flow of a data storage program that is performed by a computer (CPU) according to the embodiment of the present invention.

### DETAILED DESCRIPTION

An information processing apparatus, a data storage method, and a data storage program according to an embodiment of the present invention will now be described with reference to the attached drawings.

(1) Structure

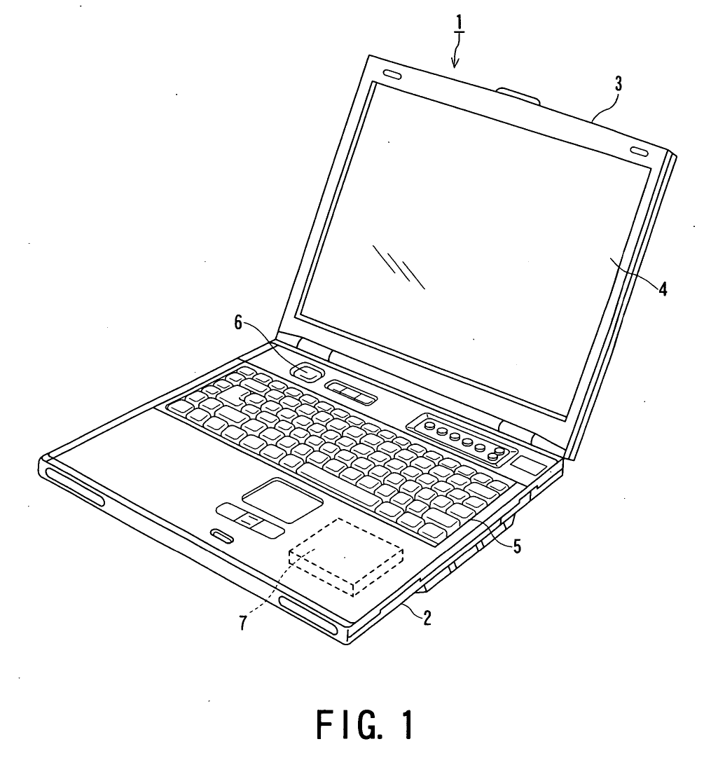

FIG. 1 is an external view of a notebook personal computer that is a typical example of an information processing apparatus 1 according to the embodiment of the present invention.

The information processing apparatus 1 includes an information processing apparatus body 2 and a panel unit 3 that are thin and rectangular-shaped. The information processing apparatus body 2 and the panel unit 3 are constructed so as to be freely opened and closed by means of hinges.

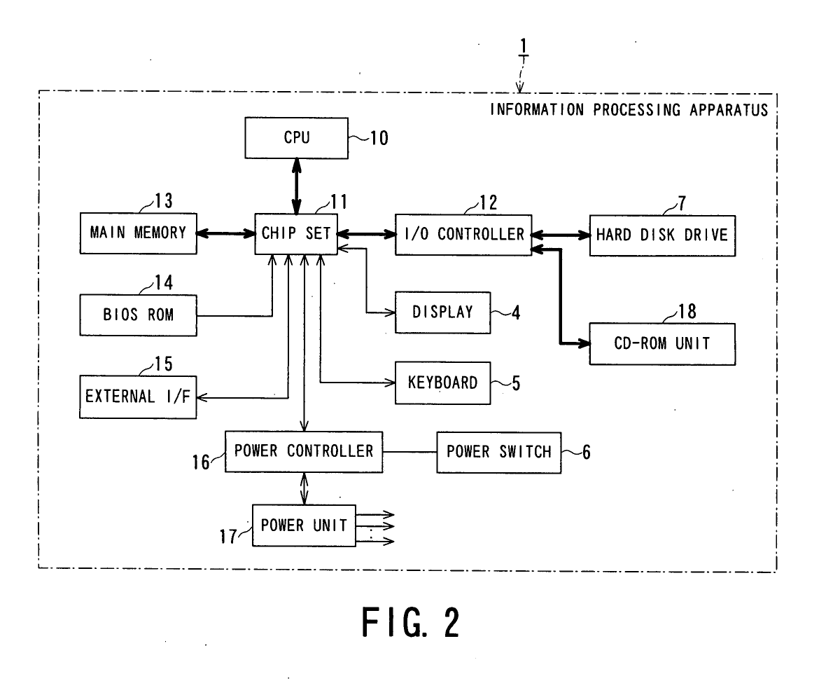

The information processing apparatus body 2 includes on the upper surface of its casing a keyboard 5 for, e.g., inputting various types of data and performing various types of manipulation of the information processing apparatus 1, a power switch 6 for turning on and off the power of the information processing apparatus 1, and the like. The information processing apparatus body 2 further includes a system board that includes electronic components (see FIG. 2), for example, a CPU 10, a chip set 11, and a main memory 13. The information processing apparatus body 2 further includes a hard disk drive 7 and a CD-ROM unit 18, as external storage units, and other components.

The panel unit 3 includes in its opening on the inside a display 4 that displays various types of information. The display 4 includes, for example, a liquid-crystal display unit.

FIG. 2 is a block diagram showing a typical system configuration of the information processing apparatus 1. The information processing apparatus 1 includes the CPU 10, which performs overall control of the system. The CPU 10 transfers data from and to various types of inner component via the chip set 11.

The main memory 13, which temporarily stores programs and data to function as a work area of the CPU 10, a BIOS ROM 14 that stores BIOS, an external I/F 15 such as a USB or a LAN, a power unit 17 that supplies power to the inner components, a power controller 16 that performs power control, and the like are provided as the inner components included in the information processing apparatus 1.

The display 4, which displays various types of information, the keyboard 5, the power switch 6, and the like are provided as the user interfaces.

The hard disk drive 7 and/or the CD-ROM (DVD) unit 18 may be provided as the external storage units. The hard disk drive 7 and the like transfer data mainly from and to the main memory 13 via an I/O controller 12 and the chip set 11 under the control of the CPU 10.

FIG. 2 shows just an example of the system configuration of the information processing apparatus 1, and the information processing apparatus 1 is not limited to this configuration. The point of the present invention is to provide a highly reliable data transfer from and to the hard disk drive 7 in the information processing apparatus 1 including the hard disk drive 7. The present invention can be widely applied to the information processing apparatus 1 that includes the hard disk drive 7. For example, other than a personal computer, the information processing apparatus 1 may be various types of server, an audiovisual apparatus that includes the hard disk drive 7, or a hand-held terminal such as a PDA or a mobile phone.

The hard disk drive 7 stores an OS and various types of application programs. The hard disk drive 7 further stores document data files, image data files, and the like generated by the application programs. These data files are read, changed, and written in response to the user operation or automatically.

Regarding the OS, some of the data files contain the startup time, data on hardware, and the like, and the content of these data files is automatically updated (read, changed, or written).

Reading and writing of data to the hard disk drive 7 are performed mainly by the CPU 10 executing a software driver that is a type of program. The software driver generates a command to control the operation of the hard disk drive 7 and issues this command to the I/O controller 12 to write and read data to and from the hard disk drive 7. The error status of the hard disk drive 7 is also checked.

(2) Functions and Operations

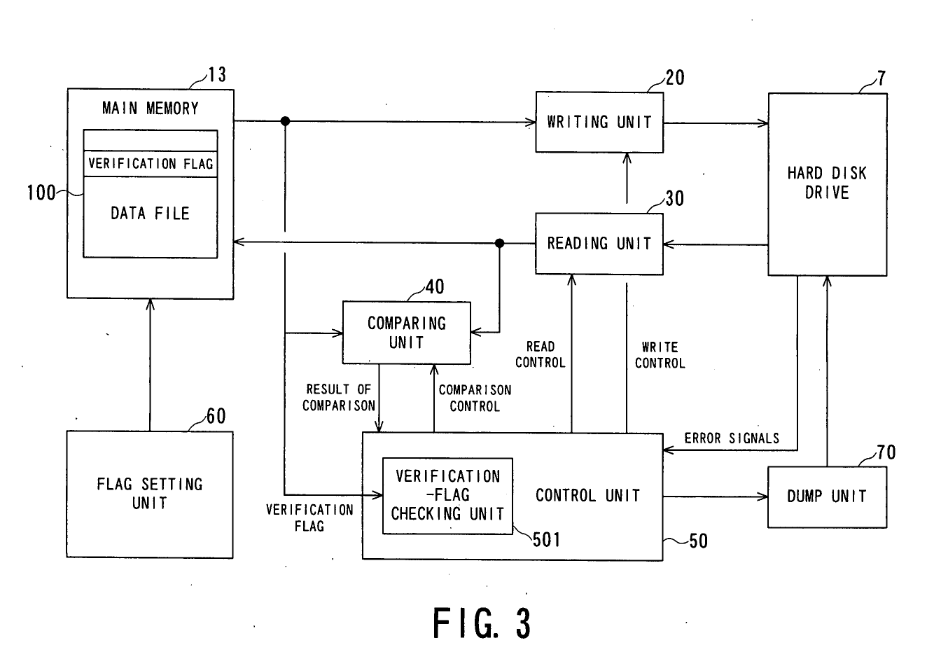

FIG. 3 is a functional block diagram showing functions provided in the information processing apparatus 1 according to the present embodiment.

The information processing apparatus 1 includes a writing unit 20, a reading unit 30, a comparing unit 40, a control unit 50, a flag setting unit 60, and a dump unit 70. The writing unit 20 writes a data file 100 that is temporarily stored in the main memory 13 to the hard disk drive 7. The reading unit 30 reads the data file stored in the hard disk drive 7. The comparing unit 40 compares the data file 100 written to the hard disk drive 7 with the data file 100 read from the hard disk drive 7 to determine whether these files coincide with each other. The control unit 50 controls the writing unit 20 and the reading unit 30. The flag setting unit 60 sets a verification flag in the data file 100. The dump unit 70 causes the hard disk drive 7 to dump all data that is temporarily stored in a buffer memory (not shown) included in the hard disk drive 7 to write the data to a real hard disk.

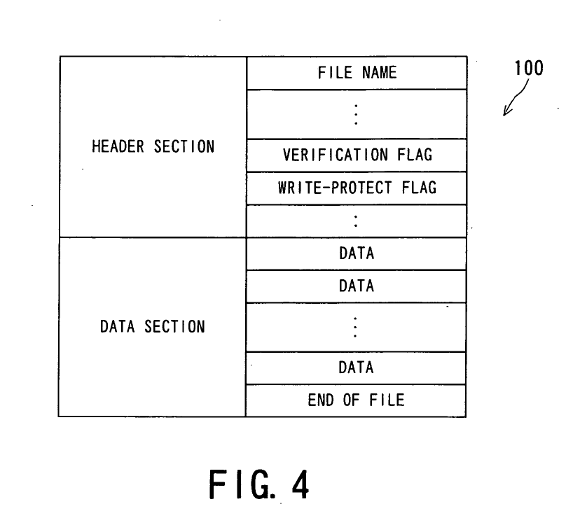

FIG. 4 is an illustration showing a typical file structure of the data file 100 handled in the present embodiment. The data file 100 includes a header section that shows the attributes of a file and a data section that includes actual data.

In general, a header section includes a write-protect flag that indicates whether write is allowed in addition to a file name. In a read-only data file, the write-protect flag is set to, for example, one. In contrast, in a data file that includes data that is changed and updated, the write-protect flag is set to zero.

In the data file 100 that is created by the user using an application program, in many cases, the user can freely set the write-protect flag to one or zero.

In contrast, an OS and an application program are basically read-only. Thus, the write-protect flag is set to one. However, even in the case of an OS and an application program, some files store variable data components, for example, the startup time and data on hardware environment. A data file that includes variable data components needs to be updated and stored in the hard disk drive 7 every time the content is changed. Thus, the write-protect flag is set to zero to allow write to the hard disk drive 7.

In the present embodiment, a verification flag is newly added to a header section, characterizing the present embodiment. A verification flag is a flag for requesting verification of the hard disk drive 7. For example, when the verification flag is set to one, verification is performed. When the verification flag is set to zero, verification is not performed.

Verification is a process in which, immediately after the data file 100 has been written to the hard disk drive 7, the data file 100 is read to determine the written and read data files coincide with each other, and when the content of the data file 100 that has been written differs from the content of the data file 100 that has been read, a sequence of rewrite, read, and matching check is repeated until the written data coincides with the read data.

When a write error has occurred in the hard disk drive 7, the error can be eliminated by this verification.

A verification flag is set for each data file by the flag setting unit 60. The configuration of the flag setting unit 60 is not limited to a specific configuration. For example, the flag setting unit 60 includes a first unit that reads each data file and a second unit that edits the header section of the read data file and adds a verification flag to the header section.

The user determines whether verification is necessary for individual data files on the basis of the types of the data files and the like. The user sets the verification flags to one only for data files for which the user determines that verification is necessary. For example, the user selects only important data files from data files created by application programs and sets the verification flags to one. On the other hand, for data files that are relatively unimportant or can be re-created, the user sets no verification flag or sets the verification flags to zero. The total time necessary for verification of the hard disk drive 7 can be reduced by selectively specifying an option of verification according to the type of the data file 100.

Even in the case of an OS and the like, the content of some data files that include variable data components is updated, and the data file 100 that has been updated is written to the hard disk drive 7. When a write error has occurred at this time, a system failure may occur, or the system may not be normally started up for the next time.

Thus, even in the case of the data file 100 of an OS and the like, verification is very effective for the data file 100 that is writable and stores variable data components, for example, the startup time and data on hardware environment. In this case, the total time necessary for verification can be reduced by selecting only corresponding data files of an OS and setting the verification flags to one.

For the data file 100 of an OS and the like, a verification flag may be set directly by the user, as with the data file 100 created by application programs, or may be set in advance by a vendor that supplies the data file 100 of an OS and the like.

In the present embodiment, even in a case where the user sets a verification flag, once the user sets the verification flag, the data is stored in the header section. Thus, the user does not need to set the verification flag every time a corresponding data file is used, and there is no heavy burden of operation.

A verification-flag checking unit 501 included in the control unit 50 determines which of one and zero a corresponding verification flag that is set in the foregoing way takes on.

When the data file 100 that has been written to the hard disk drive 7 is subjected to verification (when the verification flag is set to one), the control unit 50 causes the reading unit 30 to read the data file 100 that has been written after causing the writing unit 20 to write the data file 100.

At this time, it is preferable that the control unit 50 cause the dump unit 70 to write to a hard disk all of the data file 100 that remains in the buffer memory in the hard disk drive 7 before causing the reading unit 30 to read the data file 100.

In general, the hard disk drive 7 includes a buffer memory (functioning as a cache memory in some cases, and thus also called a cache memory) in addition to a real hard disk. The hard disk drive 7 adjusts by means of the buffer memory the speed (high speed) at which data is transferred to and from the outside of the hard disk drive 7 and the speed at which data is actually written to and read from the real hard disk. Immediately after the writing unit 20 has transferred data to be written to the hard disk drive 7, a part of the data file 100 remains in the buffer memory. Thus, when the data file 100 is read just after the data transfer, the data remaining in the buffer memory is read, and the transferred data is written to the real hard disk in parallel with or after the read operation. As the result, when an error occurs upon writing the data remaining in the buffer memory to the real hard disk, the part of the data file 100 is not subjected to matching check performed in verification.

Accordingly, in the present embodiment, the dump unit 70 forcefully dumps the data remaining in the buffer memory and writes the dumped data to the real hard disk. Then, after all of the data has been written to the real hard disk, the reading unit 30 reads the data written to the real hard disk. A highly reliable verification is enabled by the dump operation of the dump unit 70.

In addition to the result of comparing write data with read data, error signals output from the hard disk drive 7 may be used to determine whether verification needs to be performed.

In general, in the hard disk drive 7, the real hard disk stores written data to which error-detecting codes, error-correcting codes, or the like are added. Data errors can be detected by these codes upon reading data. The detected data errors, included in error signals, are output from the hard disk drive 7. Information indicating defects of the hard disk drive 7, included in error signals, is also output.

When error signals output from the hard disk drive 7 contain data errors detected by error codes or information indicating hardware defects, the reliability of data written to the hard disk drive 7 is doubtful. In this case, the reliability of written data can be improved by, for example, re-writing the data file 100.

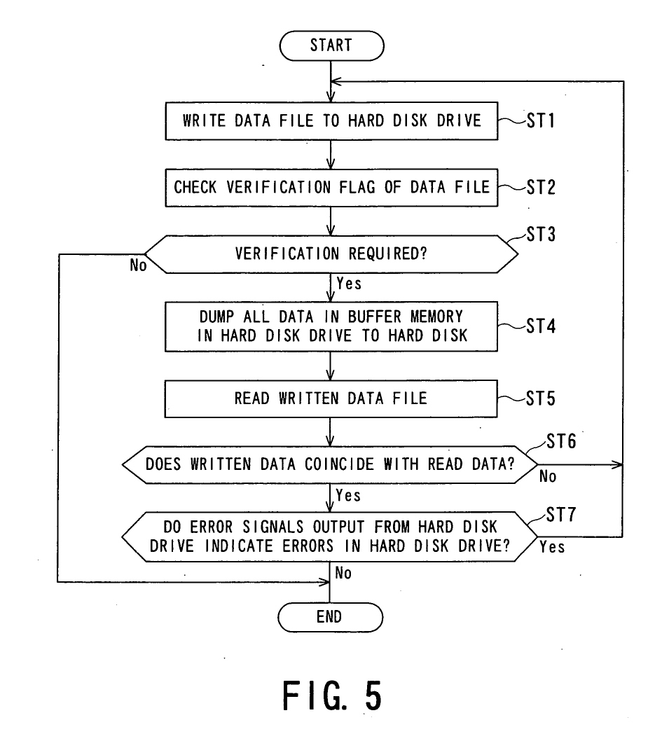

FIG. 5 is a flowchart showing a typical process flow of a data storage method and a typical process flow of a data storage program that is performed by a computer (CPU) according to the present embodiment.

In step ST1, the writing unit 20 first writes the data file 100 in the main memory 13 to the hard disk drive 7.

Then, in step ST2, the verification-flag checking unit 501 included in the control unit 50 checks the verification flag included in the header section of the data file 100.

In step ST3, it is determined whether the verification flag indicates that verification is required. When it is determined that the verification flag indicates that verification is required (when “verification is required”, or the verification flag is set to one), the process proceeds to step ST4. Otherwise, the process is completed. In step ST4, the dump unit 70 performs data dumping. That is to say, the dump unit 70 dumps all data remaining in the buffer memory in the hard disk drive 7 to the real hard disk.

Then, in step ST5, the reading unit 30 reads the data file 100 that has been written to the hard disk drive 7.

Then, in step ST6, the comparing unit 40 compares the data file 100 that has been written with the data file 100 that has been read to determine whether these files coincide with each other.

When it is determined that the data file 100 that has been written does not coincide with the data file 100 that has been read, the process goes back to step ST1, and the control unit 50 repeats a sequence of write, read, and matching check (steps ST1 to ST6) regarding the data file 100 until these files coincide with each other.

When it is determined that the data that has been written coincides with the data that has been read, the process proceeds to step ST7. In step ST7, the control unit 50 determines whether error signals output from the hard disk drive 7 indicate errors (data errors or hardware errors) in the hard disk drive 7. When the control unit 50 determines that error signals output from the hard disk drive 7 indicate errors in the hard disk drive 7, the process goes back to step ST1. Otherwise, it is determined that the data file 100 has been normally written to the hard disk drive 7, and the process is completed.

In the information processing apparatus, the data storage method, and the data storage program according to the present embodiment, verification is performed for the hard disk drive 7. Thus, the reliability of write data is improved.

Moreover, since the option of verification can be individually selected for the data file 100 by a verification flag, verification can be selectively performed for important minimum files. Thus, an increase in write time caused by verification can be minimized.

Moreover, after a verification flag is set, verification is automatically performed. Thus, there is no heavy burden on the user.

Moreover, since the process according to the present embodiment can be implemented by, for example, changing a part of a software driver, additional hardware such as a RAID device is not required, and the system configuration of an existing apparatus need not be changed. Thus, the process according to the present embodiment can be implemented at low cost.

The present invention is not limited to the foregoing embodiment. In the implementation phase, the present invention can be embodied with the components being modified without departing from the gist. Moreover, various types of aspects of invention can be made by means of appropriate combinations of the plurality of components disclosed in the forgoing embodiment. For example, some of the components disclosed in the embodiment may be eliminated. Moreover, components across different embodiments may be appropriately combined.

What is claimed is:

1. An information processing apparatus comprising:
a hard disk drive that includes a hard disk;
a writing unit that writes a data file to the hard disk;
a reading unit that reads the data file written to the hard disk;
a comparing unit that compares the data file written by the writing unit with the data file read by the reading unit; and
a control unit that causes the writing unit to perform writing, the reading unit to perform reading, and the comparing unit to perform comparison when the written data file does not coincide with the read data file.

2. The information processing apparatus according to claim 1, wherein the control unit causes the writing unit to perform writing, the reading unit to perform reading, and the comparing unit to perform comparison when the control unit determines by checking a verification flag included in the data file that the verification flag indicates that verification needs to be performed.

3. The information processing apparatus according to claim 1, wherein the hard disk drive includes a buffer memory, and the writing unit includes a unit that writes a data file stored in the buffer memory to the hard disk before the reading unit reads the data file.

4. The information processing apparatus according to claim 1, wherein the control unit causes the writing unit to perform writing, the reading unit to perform reading, and the comparing unit to perform comparison when an error signal is output from the hard disk drive.

5. A data storage method for storing data in a hard disk included in a hard disk drive, the method comprising:
writing a data file to the hard disk;
reading the data file from the hard disk;
comparing the written data file with the read data file; and
performing the writing operation, the reading operation, and the comparing operation again when the written data file does not coincide with the read data file.

6. The method according to claim 5, wherein the writing operation, the reading operation, and the comparing operation are performed again when it is determined by checking a verification flag included in the data file that the verification flag indicates that verification needs to be performed.

7. The method according to claim 5, wherein a data file stored in a buffer memory included in the hard disk drive is written to the hard disk before the data file is read.

8. The method according to claim 5, wherein the writing operation, the reading operation, and the comparing operation are performed again when an error signal is output from the hard disk drive.

9. A data storage program for storing data in a hard disk included in a hard disk drive, the program causing a computer to perform steps of:
writing a data file to the hard disk;
reading the data file from the hard disk;
comparing the written data file with the read data file; and
performing the writing operation, the reading operation, and the comparing operation again when the written data file does not coincide with the read data file.

10. The program according to claim 9, wherein the program causes the computer to perform a step of performing the writing operation, the reading operation, and the comparing operation again when it is determined by checking a verification flag included in the data file that the verification flag indicates that verification needs to be performed.
